(19) United States
(12) Patent Application Publication
(10) Pub. No.: US 2013/0139681 A1
(43) Pub. Date: Jun. 6, 2013

(54) TELESCOPIC ACTUATOR

(71) Applicants: Wieslaw Nowak, Krosno (PL); Zygmunt Nowak, Krosno (PL); Janusz Nowak, Krosno (PL)

(72) Inventors: Wieslaw Nowak, Krosno (PL); Zygmunt Nowak, Krosno (PL); Janusz Nowak, Krosno (PL)

(21) Appl. No.: 13/817,994

(22) PCT Filed: Aug. 18, 2011
(86) PCT No.: PCT/PL2011/000088

§ 371 Date: Feb. 20, 2013

(30) Foreign Application Priority Data
Aug. 20, 2010 (PL) P.392187

(51) Int. Cl. F15B 15/20

(52) U.S. Cl. CPC F15B 15/20
USPC 92/145

(57) ABSTRACT

The subject matter of this invention is a telescopic actuator with tubular cylinders which at the same time function as pistons, used to move/shift/translocate pieces of devices especially while emergency opening damaged movable elements/components. It has a bushing body (1) connected with a head (5) attached to its free end and the head has a control segment (10) and the systems feeding the actuator with pressure agent/factor, created in the form of at least one gas generator (9); and by the fact that the bushing/sleeve body (1), the first cylindrical piston (2) and another cylindrical piston (3) have at least one ring groove situated on the surface mating with another tubular element near the head faces of those tubular elements.

The subject matter of this invention is a telescopic actuator with tubular cylinders which also function as pistons, used to move/shift/transfer pieces of devices especially while emergency opening damaged movable elements/components.

Hydraulic telescopic actuators are known, composed of several cylinders of relatively short length of a collapsed actuator. There is also a bi-telescopic actuator composed of a cylinder in which an external piston rod is installed with an internal piston rod installed in the external piston rod. One end of the cylinder is closed with a bottom and both piston rods protrude out of the other end, while the space between the cylinder and the outer piston rod, called the side over-piston space, is closed with a choking bushing, and the space between the outer and inner piston rod, called middle over-piston space, is closed with a gland/packing. Both piston rods are moved both ways under the pressure of a working agent supplied to the inside of the actuator, but the moving-out action of both piston rods is effected after the sub-piston spaces are fed with an agent flowing through a connection and a small groove, which are placed in the cylinder close to its bottom.

There is also a bi-telescopic actuator known from the Polish patent description 165933, which has a cylinder with two telescopic piston rods activated/moved by the pressure of a working agent introduced inside the actuator through lines fitted to connections linked through grooves with the inner spaces, feeding the over-piston spaces of this actuator.

Another hydraulic telescopic lift (jack), known from the Polish patent description of invention number 188431, features an inlet of hydraulic fluid, a base, a corrosion-resistant outer tube with its one end installed on the base along with a gasket between them and the other end open, with at least one intermediary corrosion-resistant tube placed in the outer tube in telescopic position, whereas the intermediary tube has inner and outer ends and it is moved out from the open end of the outer tube to a protruded (moved-out) position and it is moved into through the open end of this tube to collapsed position. Besides, this lift has got hydraulic sealing fitted around the bottom end of the intermediary tube and constituting the sealing between the intermediary tube and the outer tube, and also it has a bearing with a gland nut fitted to the open end of the outer tube, intended to retain the position of the inner end of the intermediary tube relative to the outer tube. The point of this telescopic lift is that there is some air space between the intermediary tube and the outer tube, and the outer tube has a relief air valve installed in it, which is connected with the air space. Patent description 51071 presents an actuator of varied spacing of leading bushings which are located near one end of the piston rods. The ends of the actuator's tubes located at the pressure input are open, to let the feeding pressure pass through, and they have only limit ring restricting the stroke/travel of the actuator's cylinders/piston rods.

The Polish patent description 194447 demonstrates a small-size actuator for emergency opening of vehicle doors, using pyrotechnic charges, whose cylinders are vented (emptied) by a solenoid valve.

The basic disadvantage of the known configurations of pneumatic and hydraulic actuators is the fact that they are composed of a relatively large number of parts which require machining, i.e. turning, milling, grinding, polishing, honing etc. Furthermore, the pistons fitted in cylinders, as it is difficult to obtain high precision of the nominal dimensions of the cylinders' diameters, do not assure required tightness, especially when the pistons are activated (moved) by a gaseous agent or by another agent of high working pressure.

Besides, the telescopic lift, known from the patent description: U.S. Pat. No. 4,471,944, has got a number of coaxial tubular telescopic elements installed in the cylinder, and each pair of adjacent tubular telescopic elements has two pairs of co-working ring-shaped hollows on their outer and inner surfaces, which cooperate with a resilient ring in order to restrict the movement of the inner tubular element to the outside relative to the neighboring/adjacent outer element. In this embodiment the lateral surfaces are guides for the sliding-out elements and the resilient rings are placed in small grooves which, during the lift operation, are compressed and expanded and at the same time they move out and into the small grooves.

This embodiment's drawback is the necessity to machine the ring grooves with high precision and if this condition is not met, the resilient ring stroke may be blocked and the telescopic element may be moved out of the cylinder and, furthermore, low precision results in the faster wear out of both grooves and rings. Apart from that, this embodiment may result in getting stuck, soiling or fracture of the resilient ring, which, in turn, may result in unsafe operation of the actuator as the ring does not move out.

The purpose of this invention is to develop a telescopic actuator embodiment of a much simpler and compact and more reliable configuration, reducing substantially the machining operations on its parts and providing reliability of function, especially when the actuator is activated by means of a gaseous agent. The coaxially installed cylindrical pistons are fitted with sealing-guiding-and-stopping rings on both ends of the cylindrical pistons. The closure of both ends of the cylindrical pistons forms a shock-absorbing/buffering cushion of the air trapped in the small ring spaces between the cylindrical pistons and it supports the stroke stops at the end of the move-out motion. Besides, the closed space gives a possibility to introduce lubricants and sliding agents.

The purpose of the invention has been achieved in a telescopic actuator composed of a bushing body/housing and cylindrical pistons of diminishing diameters installed inside the housing and inside one another, and sequentially moving out as a result of the pressure agent action, the actuator having the tubular body connected with a head, attached to one of its ends and having a control segment and the systems feeding the pressure agent to the actuator, the systems consisting of at least one gas generator. The bushing body and the first cylindrical piston and another cylindrical piston have at least one ring groove located on the surface mating another tubular element, close to the end faces of those tubular elements. At least one ring or at least one ring-assembly composed of at least two rings is placed in this groove/those grooves, and the rings/ring-assemblies function as guides and sealing of those tubular elements, the function being performed by the ring/rings circumference and the stop function is performed by the end faces of the ring/rings, and the functions can be divided among/shared by particular rings or ring-assemblies following one after another, or they may be integrated in a single ring. The function of sealing and guiding is performed as a result of mating of the particular rings or the ring-assemblies with the tubular elements of the body, the first tubular piston and the second tubular piston, as cylindrical tubes of high dimensional precision and cylindrical-shape precision of their outer and inner diameters and low surface roughness.

The telescopic actuator has a control segment and at least one gas generator which are installed in the head in graduated holes in a plate fitted in the head and they are secured by a pressing stop-plate with a securing ring. The electric leads necessary for their function are led out through a side opening in the head wall, while two-stage head stopper/plug constitutes the first stop/resistance surface of the actuator.

The control segment of the actuator is a detector sensing at least pressure, travel distance or pressure and travel distance of the actuator and transferring the signal, controlling the means which change the pressure magnitude in the actuator, to the actuating elements. The telescopic actuator has a support bushing installed on the outer wall of the tubular body/housing. The other stop/resistance surface of the actuator is a pressing element with a cylindrical retaining protrusion and a sealing ring, mating the outer surface of the actuator's tubular body/housing, in the status of moved-out (protruded) cylinders of the actuator. With pre-determined dimensional parameters of tubes, the sliding parameters of the actuator are determined by the sizes of the ring grooves and by the shape or the set of the rings placed in them.

The simplified, shorter variety of the actuator has one cylindrical piston sliding inside the bushing-shaped/tubular body/housing.

The construction/configuration embodiment of the telescopic actuator as per the invention reduces to a minimum the number of parts and components. The functions of simultaneous guiding, sealing, limitation/stopping of stroke/travel and the shock-absorbing cushion of the air trapped in the ring spaces between the cylinders are performed by the rings or the ring assemblies. They are situated on both ends of the cylindrical pistons in the grooves on the precision tubular surfaces. Their functions may be distributed among particular rings or the ring assemblies (they may be shared by the particular rings or ring assemblies). The control segment of the actuator provides immediate response to the position of the actuator's cylinders by sending a signal to actuating systems.

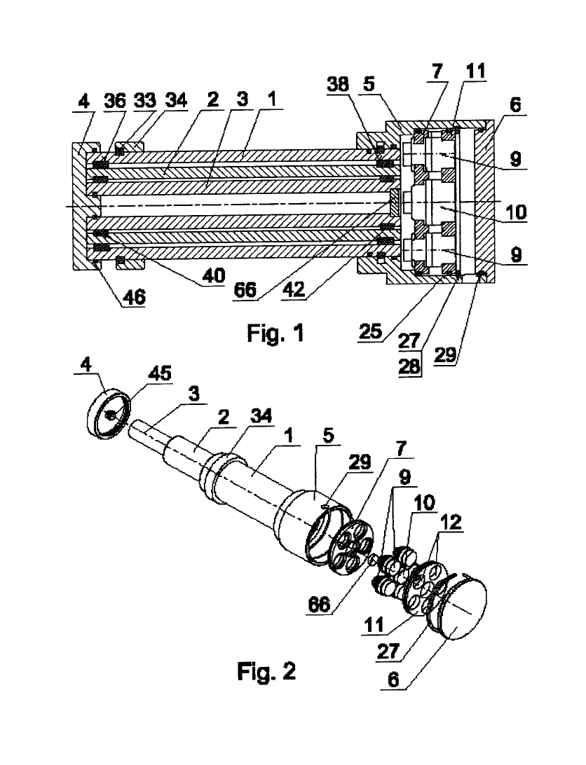

The subject matter of the invention has been visualized in the examples, as it was made, in the drawings attached where FIG. 1 shows the telescopic actuator with single rings in axial section;

FIG. 2 shows the actuator expanded in perspective view;

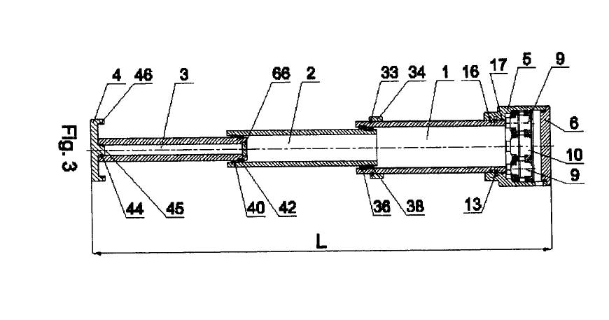

FIG. 3 shows the actuator with its pistons moved out from its cylindrical body/housing to the maximum length (travel) “L”, in the axial section;

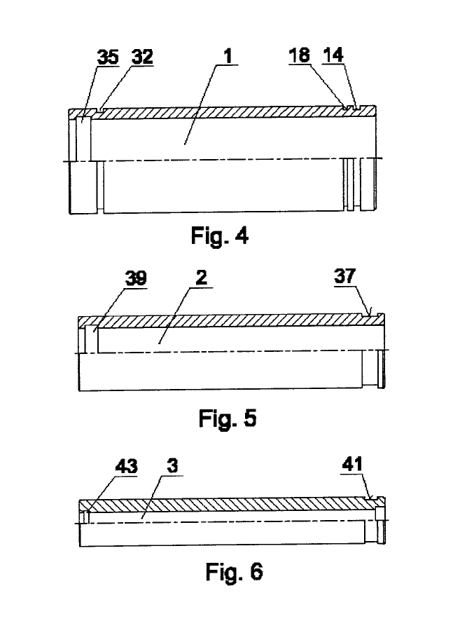

FIG. 4 shows the body/housing of the actuator with the ring grooves, in the axial half section—half view;

FIG. 5 shows the cylindrical piston of this actuator with its ring grooves, in the axial half section—half view;

FIG. 6 shows the second cylindrical piston with its ring grooves, in the axial half section—half view;

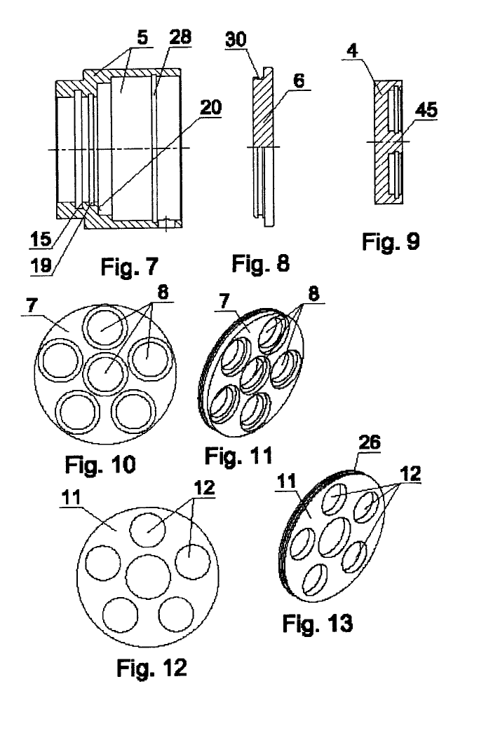

FIG. 7 shows the actuator head in the axial section;

FIG. 8 shows the actuator's head plug in the axial section;

FIG. 9 shows the separable pressing element covering one end face of the actuator in the axial section;

FIG. 10 shows the front view of the gas generators' plate;

FIG. 11 shows the same plate in a perspective view;

FIG. 12 shows the front view of the pressing/retaining plate of the gas generator;

FIG. 13 shows the same pressing/retaining plate in a perspective view.

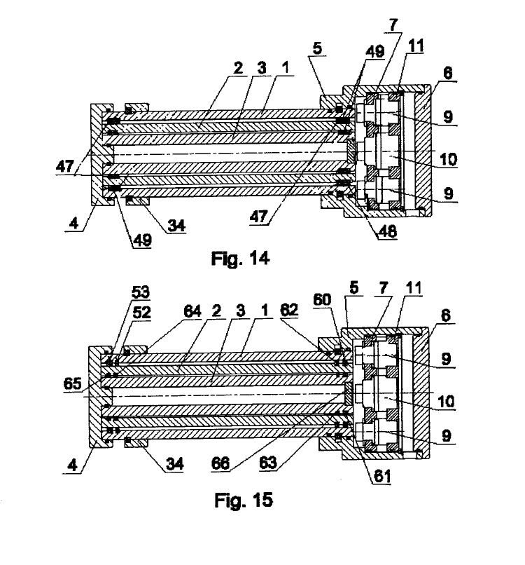

FIG. 14 shows another option of producing the telescopic actuator with the ring assemblies in one groove, in the axial section;

FIG. 15 shows the third variant of the telescopic actuator configuration with single rings in separate grooves, in the axial section;

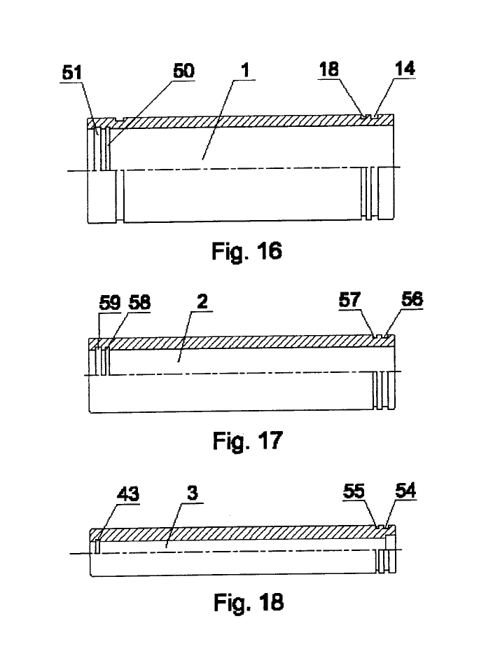

FIG. 16 shows the cylindrical body/housing with two grooves, in the half section half view;

FIG. 17 shows the first cylindrical piston of the third variant of the actuator, in the half section—half view;

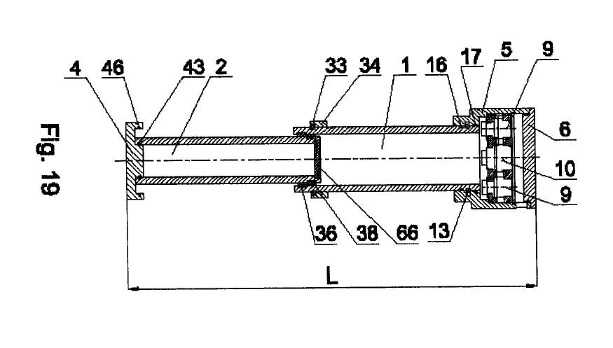

FIG. 18 shows the second cylindrical piston of the third variant of the actuator, in the half section—half view;

FIG. 19 shows the fourth variant of the telescopic actuator's configuration with one cylindrical piston only, in the axial section.

The telescopic actuator in the first example of configuration, presented in FIGS. 1-13 is made up of a bushing/tubular body/housing (1), two cylindrical pistons (2 and 3) coaxially installed in it, fitted together one in the other and installed on this body/housing and inside the second cylinder (3), pressing element (4) covering one end face of both cylindrical pistons (2 and 3) and a bushing/tubular body/housing (1), on the other end of which the head (5) is fitted, the outer end face of which is covered by a plug (6), and a round plate (7) is fitted in the head (5), with the gas generators (9) fixed in the graduated openings (8) in the plate, and the pressure control segment (10) installed between them, and/or the routes of travel/stroke; the gas generators and the sensor are pressed/retained with a retaining plate (11) featuring round openings (12). The actuator's head (5) is installed on the outer surface of the rear end of the bushing/tubular body/housing (1) with a securing/protecting ring (13), installed in the ring grooves (14 and 15) located opposite each other, made respectively on the inner surface of the head (5) and on the outer surface of the bushing/tubular body/housing (1), and there are two sealing rings (16 and 17) located on both sides of the protective ring (13), and the ring (16) is placed in the ring groove (18) made on the outer surface of this body and ring (17) is placed in the ring groove (19) made on the outer surface of the head (5). A plate (7) with a sealing ring and the gas generator(s) (9) installed in it is adjacent to the ring-shaped inner end face (20) of the head (5) and with a control segment (10) sensing the pressure and/or the actuator travel (distance); the generators also have the sealing rings, and a sealing ring (25), inserted in its ring groove (26), is placed on the plate (11) retaining (pressing) the generators and the sensor, and the plate's outer end face is pressed with a securing ring (27) inserted in the ring groove (28) of this head with a two-stage plug (6) installed inside the head (5) and adjacent to its end face, and a sealing ring (29), inserted in the ring groove (30) on the plug, is placed between the inner surface of the head and the outer surface of the plug (6).

The plug, at the same time, constitutes the first resistance surface of the actuator. Further, the front end of the bushing body (1) has a ring groove (32) on the body's outer surface, and there is a stop/resistance ring (33), placed in the groove, and a stop/resistance bushing (34) installed on the body is set against the ring (33); and the ring also functions as a supporting element of the actuator, and on the inner surface of the body (1), near its end face, it has a ring groove (35) with one ring (36) inserted in it.

In turn, the first cylindrical piston (2) installed coaxially in the sleeve body (1) has got—on its outer surface close to its rear end face, on the side of the gas generators (9)—a ring groove (37) with one ring (38) inserted in it, and on the piston's inner surface, near the piston's front end face, the piston (2) has a ring groove (39) with one ring (40) inserted in it. Another cylindrical piston (3), of smaller diameter, installed coaxially within the cylindrical piston (2), has—on its outer surface and near its rear end face—a ring groove (41) with a ring (42) inserted in it, and on the second piston's inner surface, near its front end face, there is a ring groove (43) with a ring (44) inserted in it, and a cylindrical protrusion (45)—installed inside the cylindrical piston—of a pressing element (4) set on the front end face of the bushing body (1), with an adjacent/mating sealing ring (46), in the collapsed (folded, not-expanded) position of the actuator's cylindrical pistons. The mating rings (36 and 38) as well as (40 and 42) of the cylindrical pistons (2 and 3) of the actuator have properly selected thicknesses and when the actuator's both cylindrical pistons (2 and 3) are in an expanded (moved out) position to the maximum length “L” from the actuator's bushing body (1), the neighboring faces of these rings pairs mate with a pressure (with a resistance/with a stop).

The telescopic actuator as per the second example of its embodiment is shown in FIG. 14, but in the ring groove (35) of the bushing body and in the ring grooves (37), (39) and (41) of the cylindrical pistons (2 and 3) the ring sets/assemblies (47, 48) and (49) are inserted.

In turn, the telescopic actuator as per the third example of its embodiment, shown in FIG. 15, is also made up of the same elements as the actuator as per the first example of its embodiment, shown in FIG. 2 and FIGS. 4-13, but the bushing body (1) has two ring grooves (50) and (51), located one next to the other, on its inner surface, near its front end face, with the rings (52), (53) located individually in the grooves. Besides, the bushing pistons (2 and 3)—on their both ends, near their end faces, on their inner and outer surfaces—also have two pairs of grooves (54 and 55), (56 and 57), as well as (58 and 59), located one next to the other, respectively, and the rings (60 and 61) are inserted in the grooves (54 and 56), and rings (62 and 63) in grooves (55 and 57), and the ring (64) is inserted in the groove (58), and the ring (65) in the groove (59).

The telescopic actuator as per the fourth example of its embodiment, shown in FIG. 19 and FIGS. 4, 5 and FIGS. 7-13, is made up of the same elements as the actuator as per the first example of its embodiment, shown in FIGS. 1-2 and FIGS. 4-13, but it has only one expandable (moving out/sliding out) cylindrical piston (3) installed in the bushing body (1).

In all the examples of embodiment of the telescopic actuators, each internal cylindrical piston (3) or (2) has a plugged end located on the side near the head (5), with a plug (66) inserted in them, and the head (5) on its perimeter has an opening (29) for the electric wires to be inserted to control the function of the gas generator(s) (9) and of the control segment (10).

In all the examples of embodiment of the actuator the head (5) with the control segment (10) with one or more gas generator(s) (9) can be installed. The control segment (10) provides current parameters of the actuator and sends a signal to the devices controlling the actuator's function, in order to change the pressure supplied, by sequential activation of the gas generators (9) [one after another].

If the actuator has a long stand-by time before it is activated, for example in devices in which it is awaiting emergency situations, then, with its pistons collapsed (not-expanded) and held within, the inside of the actuator is protected from soiling and moisture by a seal (46) tight-sealing the bushing body (1) on its circumference at its upper end face.

Also in all the telescopic embodiments, both the sleeve body (1) and the cylindrical pistons (2 and 3) have been manufactured of cylindrical tubes of high dimensional precision of their nominal inner and outer diameters and having minimal deviations from their cylindrical shape and low surface roughness. It was the high dimensional precision of the tubes that made it possible to manufacture the sleeve/bushing body (1) and the cylindrical pistons (2 and 3) installed in it and to ensure the sliding and abrasive properties of the working surfaces and easy sealing and guiding by the use of well-selected dimensions of grooves and mating rings/rings sets (rings assemblies). In the event of wider grooves there is also a possibility of alternative use of a single wider ring or a set of narrower rings of varying properties.

The actuator as per the invention can be applied for moving/shifting elements of devices, including the elements of vehicles, especially in cases of emergency, for example to open the jammed vehicle doors, damaged safety doors/hatches or emergency exits in buildings. The actuator can also be used in devices in which there is a limited area for its installation as it has a compact configuration when its pistons are collapsed (not expanded).

1. Apparatus for pivotal movement of a plate (11), in particular at a bar counter (10), such as a cooling, sales or self service counter,
with a stationary bearing part (15) for a pivotally mounted thereto joint part (20), wherein the plate (11) and a substantially horizontal pivot axis (12),
about which the plate (11) is pivotable between a lowered position (11.1) and a raised position (11.2) in a substantially vertical pivoting plane (13),
and with an energy storage element (30) serving as a lifting help for lifting the plate (11) serving for energy storage (30),
wherein the energy storage element (30) has two terminal ends (31, 32),
and wherein two counter-connection ends (14, 21) are furnished, of which one counter connection end (21) is disposed co-movable on the joint part (20) and the other counter connection end (14) is fixedly arranged on the bearing part (15),
wherein the connection ends (31, 32) and the counter-connection ends (14, 21) are formed as parts of ball and socket joints (35),
characterized in
that at least one of the connecting ends (31, 32) of an energy storage (30) is formed as a ball socket (33), while the counter connection end (14, 21) disposed at the joint part (20) or, respectively, at the bearing part (15) is formed as a spherical head (34)
that the two connecting ends (31, 32) of an energy storage (30) are constructed differently, and only with one of the counter-connection ends (14, 21) on the joint part (20) or on the bearing part (15) can be brought in mechanical operative connection,
and
that a securing element (40) is furnished, which securing element (40) secures two parts (33, 34) of at least one ball and socket joint (35) including a ball socket (33) and a ball head (34), of the respective force storage (30), at each other in an incorporated state.

2. Apparatus according to claim 1 characterized in that said one connection end (31) of the force storage (30) is a ball socket (33) and the other (32) is a spherical head (34) are formed and one ball head (34) and one ball socket (33) are used as counter-connection points (14, 21) which are arranged on the joint part (20) or on the bearing part (15), wherein during the assembly respectively a ball head (34) with a ball socket (33) can be brought into mechanical operative connection.

3. Apparatus according to claim 1, characterized in that the two connecting ends (31, 32) of the force storage (30) are formed as ball sockets (33) and in each case one ball head (34) as a counter-connection point (14, 21) is disposed on the joint part (20) and arranged on the bearing part (15), and
that the two spherical heads (34) serving as counter connection points (14, 21) have different diameters, and the two ball sockets formed as connection points (31, 32) are adapted in each case to one of these two diameters.

4. Apparatus according to claim 1, characterized in that the securing element (40) is a spring which at least partially encompasses both the ball head (34) and the ball socket (33) and this way secures the ball and socket joint (35) in the mounted state.

5. Apparatus according to claim 4, characterized in that the ball socket (33) has one or more slot-shaped recesses (36) through which the securing element (40) can be guided to secure the ball head (34) to the ball socket (33).

6. Apparatus according to claim 1, characterized in that two power storages (30) are used for each plate (11), wherein the two power storages are disposed mirror symmetrical relative to the pivot plane (13) of the plate (11).

7. Apparatus according to claim 1, characterized in that
piston-like components, such as hydraulic cylinders, gas springs or gas pressure cylinders serve as force storage (30).
